(19) United States
(12) Patent Application Publication
(10) Pub. No.: US 2016/0307005 A1
(43) Pub. Date: Oct. 20, 2016

(54) Label, Information Verification System, and Information Verification Method

(71) Applicant: SOOKU TECHNOLOGY LIMITED, Hong Kong (HK)

(72) Inventors: King On Stephen Poon, Hong Kong (HK); Yip Keung Chan, Hong Kong (HK)

(21) Appl. No.: 15/099,625

(22) Filed: Apr. 15, 2016

Related U.S. Application Data
(63) Continuation of application No. PCT/CN2014/088875, filed on Oct. 17, 2014.

(30) Foreign Application Priority Data
Oct. 17, 2013 (HK) 13111734.3

(51) Int. Cl. G06K 5/00; G06K 7/10; G06K 19/06

(52) U.S. Cl. CPC G06K 5/00; G06K 19/06037; G06K 7/10861; G06K 19/06056; G06K 19/06028

(57) ABSTRACT

An anti-counterfeit label includes a label body provided thereon with a first code and a second code. The second code is superimposed on the first code. The second code is a combination of code elements of at least one color at at least one position in a region where the first code is located on the label body. An anti-counterfeit system includes a cloud platform and a mobile device. The mobile device is used to scan the image formed by the combination of the first code and second code and send it to the cloud platform. The cloud platform is used to authenticate the image, and send information that corresponds to the image to the mobile device after successful authentication. An anti-counterfeit authentication method is also provided. The label, authentication system and method provide a combination code of the first code and the second code for information authentication.

### FIELD OF THE TECHNOLOGY

The present application relates to anti-counterfeit authentication technology, and particularly to an anti-counterfeit authentication system and an anti-counterfeit authentication method.

### BACKGROUND OF THE TECHNOLOGY

In commercial activities, merchants often provide a special identification for their own products or services in order to show that they are different from other merchants. However, many unscrupulous merchants will forge the identification of some celebrated merchants so that customers mistakenly believe that the products are from these celebrated merchants and purchase fake and shoddy products with quality and safety that do not meet customer's expectation. This causes adverse impact on celebrated merchants, damage to their reputation, and drop in sales. Hence, anti-counterfeit authentication technology is developed to distinguish genuine products of merchants from fake products of illegal merchants. Currently, some anti-counterfeit authentication methods include the use of anti-counterfeit labels on products. Two-dimensional codes, such as QR (Quick Response) codes are provided on labels. The two-dimensional codes contain information on products or services of merchants. Customers can use an image-recording device to scan the anti-counterfeit label in order to obtain the product or service information, or send the two-dimensional code to an authentication website for authentication in order to ascertain the validity of the products and services.

A two-dimensional code is an image with alternating black and white distributed on a flat surface (i.e. in two-dimensional direction) according to certain specific geometry and pattern for recording data, symbols and information. Usually, it is a matrix code. It contains black and white blocks arranged in a pattern within a predetermined rectangular region to represent data 1 or 0. All possible combination of arrangement of the black and white blocks within the predetermined rectangular region form the data field of the two-dimensional code.

However, the current anti-counterfeit two-dimensional code is relatively simple and can be easily duplicated. It does not serve any real anti-counterfeit purpose. In addition, the information in current anti-counterfeit authentication is relatively fixed, and it cannot provide a complete tracking of the products.

### SUMMARY

The present application provides a label, an information authentication system and an information authentication method, include:

a label having a label body, and the label body is provided thereon with a first code and a second code, the second code being superimposed on the first code, the second code is a combination of code elements of at least one color at at least one position in a region where the first code is located on the label body.

The label body is a multilayered structure, and the first code and the second code are located on different layers of the label body.

The label body includes a film, a copper plate paper, or a card paper.

A rear surface of the label body is coated with an adhesive layer.

An information authentication system of the present application includes a cloud platform for communicating with a mobile device; the cloud platform being configured to carry out authentication of an image formed by the combination of the first and second codes on the label collected and transmitted from the mobile device, and sending information that corresponds to the image to the mobile device after successful authentication.

The information authentication system further includes an authentication failure prompting message to be transmitted from the cloud platform to the mobile device when authentication fails.

The information comprises tracking information on an item on which the label is attached.

The tracking information comprises information on time and place of purchase, production, logistics, and sale.

The mobile device is a camera-enabled notebook computer or smart phone.

The present application provides a method of authentication of information using the information authentication system, including:
collecting the image on the label attached to the item by the mobile device, the image being formed by the combination of the first and second codes, wherein the second code is the combination of code elements of at least one color at at least one position in the region of the first code;
receiving the image collected from the mobile device by the cloud platform, comparing the image with reference images in a cloud database, extracting a code value sequence that corresponds to the first code and a code value sequence that corresponds to the second code, and combining the code value sequence that corresponds to the first code with the code value sequence that corresponds to the second code according to a predetermined combination method so as to obtain a code value sequence that corresponds to the image;
obtaining information that corresponds to the code value sequence that corresponds to the image by the cloud platform according to a predetermined code value-information corresponding relationship, and transmitting the information that corresponds to the code value sequence to the mobile device.

The code value sequence is one or more combinations of numbers, letters and characters.

The predetermined combination method comprises directly adding the code value sequence that corresponds to the second code after the code value sequence that corresponds to the first code.

The information authentication method further includes updating the predetermined combination method or the code value-information correspondence relationship periodically or in response to a command.

The present application provides a label including a label body, and the label body is provided thereon with a color position code, the color position code being a combination of code elements of at least one color at at least one position on the label body.

The color position code has a code word region which is triangular, rectangular, circular, or square in shape.

The label body is provided thereon with a code set formed by a plurality of the color position codes.

The code word region of the code set is T-shaped or heart-shaped.

The color position code of different shapes corresponds to different code mapping tables during coding.

The present application provides an information authentication method based on the label, wherein information authentication is carried out by an information authentication system, the information authentication system including: a cloud platform for communicating with a mobile device; the cloud platform being configured to carry out authentication of an image formed by the color position code on the label collected and transmitted from the mobile device, and sending information that corresponds to the image to the mobile device after successful authentication; the method including:
collecting the image on the label attached to an item by the mobile device, the image being an image of the color position code;
receiving the image collected from the mobile device by the cloud platform, comparing the image with reference images in a cloud database, obtaining a code value sequence that corresponds to the image utilizing a code mapping table according to shape of the color position code;
obtaining information that corresponds to the code value sequence that corresponds to the image by the cloud platform according to a predetermined code value-information corresponding relationship, and transmitting the information that corresponds to the code value sequence to the mobile device.

The information authentication method further includes transmitting an authentication failure prompting message from the cloud platform to the mobile device when authentication fails; wherein the information comprises a tracking information on the item on which the label is attached, and the tracking information comprises information on time and place of purchase, production, logistics, and sale; and wherein the mobile device is a camera-enabled notebook computer or smart phone; the code value sequence being one or more combinations of numbers, letters and characters; and further comprising updating a predetermined combination method or the code value-information corresponding relationship periodically or in response to a command.

The present application provides a label, authentication system and method including a combination code of the first code and the second code for information authentication. The combination codes are not easy to duplicate. They can have good anti-counterfeit effect, carry a large amount of information, completely record tracking information on products, and update authentication information.

### BRIEF DESCRIPTION OF THE DRAWINGS

Specific embodiments will now be described by way of example with reference to the accompanying drawings wherein:

FIG. 1 is an illustrative diagram of encoding of a SC code of an embodiment of the present application;

FIG. 2 is a structural diagram of a label of an embodiment of the present application;

FIG. 3 is a block diagram of an information authentication system of an embodiment of the present application;

FIG. 4 is an illustrative diagram of an information tracking procedure of an embodiment of the present application;

FIG. 5 is an illustrative diagram of a T-shaped CP code of an embodiment of the present application;

FIG. 6 is an illustrative diagram of a heart-shaped CP code of an embodiment of the present application.

### DETAILED DESCRIPTION

In order to have a clear understanding of the technical features, objects and effects of the label of the present application, specific embodiments will now be described in detail with reference to the accompanying drawings.

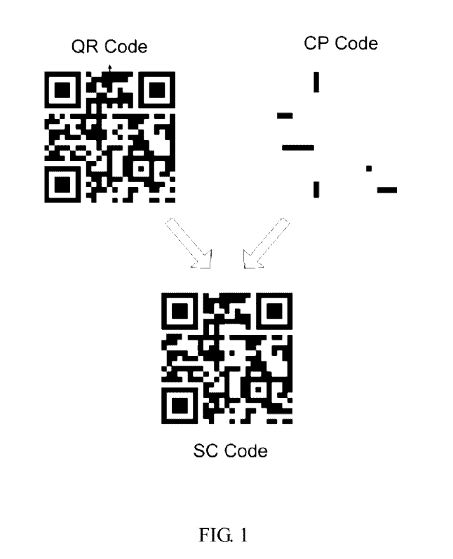

As shown in FIG. 1, the present application provides a combination code for carrying out information authentication. In the embodiment of the present application, the combination code is known as a SC code. The SC code may include a first code and a second code, wherein the first code can be a two-dimensional code, such as a QR code. In the present application, the second code is known as a CP (colors positioning) code, which can be a combination of code elements of at least one color at at least one position in a region where the first code is located. FIG. 1 exemplarily shows a CP code having 9 code elements. According to a predetermined manner, the 9 code elements may be assigned with different colors, such as red, blue, green, etc. The choice of color is not limited. Different code elements may have different colors or have the same color.

The region of the first code is called a code word region. The first code usually contains a plurality of code elements. The code elements occupy portions of the code word region respectively. Each portion is called of a code element region that corresponds to each code element. The code elements of the second code can be distributed within the code element regions of the first code. It is necessary to note that the number of code elements of the second code may not be the same or may be less than that of the first code. In addition, the position of each code element of the second code (known as code element position of the second code) may not necessarily correspond to the code element region of the first code. Two or more code elements of the second code may be distributed in one code element region of the first code.

CP is characterized by the position and color of each code element. In addition, its shape can also be used to distinguish its characteristic. Using different combinations of the color, position and shape of the CP, a large number of different combinations of code element of the second code can be formed. Different numbers, letters, or characters, etc. that correspond to different code elements can be predetermined in advance. For example, the topmost vertical bar of the CP code shown in FIG. 1 can be set to correspond to number “1” (i.e. a code element of the second code, for example is purple). Other code elements may correspond to different numbers, letters or characters according to predetermined corresponding relationship. Hence, a CP code may correspond to a specific combined sequence of numbers, letters or characters. This sequence is known as a code valve sequence of the second code. The specific numbers, letters or characters of the position and color of the code elements of a CP code can be predetermined in a mapping relationship table. Then, the process of encoding and decoding can be carried out according to the mapping relationship table. Similarly, all regions of the CP code are its code word region, i.e. the region occupies by a complete CP code sequence. The region occupied by each code element of the CP code sequence is its code element region. For example, the code word region of the CP code can be a rectangular region with three rows and three columns. As such, it will contain 9 code element regions. The code element regions may have the same color mapping relationship, or different color mapping relationship. The colors can be colors such as red, orange, yellow, green, cyan, blue, purple, etc. For a different color mapping relationship, for example, red color appearing in the first row first column of the 9 regions may correspond to number “1”. However, red color appearing in the second row second column does not necessarily correspond to number “1”. It can be set to correspond to letter “a”. In this case, correspondence can be carried out based on the absolute code element position of the CP code. Similarly, it can be carried out based on the corresponding code element position of the QR code. For example, correspondence can be carried out based on the relative displacement relationship of the position of a certain code element of the CP code and the position of a certain code element of the QR code.

On the other hand, re-encoding or encrypting process can be further carried out on the combined sequence so as to obtain the sequence after conversion. The numbers, letters or characters in the sequence after conversion can hide the corresponding relationship between the position and color of each code element and the predetermined numbers, letters or characters. This can avoid cracking of the corresponding relationship by illegal merchants. This can raise the security of the CP code. Not specifically pointed out in the present application, the code value sequence that corresponds to the second code can refer to the sequence before encoding or encrypting, or the sequence after encoding or encrypting. The encoding or encrypting method can be specifically changed at any time or can be changed periodically by the merchants.

Similarly, code value sequence that corresponds to the first code can also be formed. The code value sequence that corresponds to the first code and the code value sequence that corresponds to the second code can be combined according to a predetermined combination method. One possible combination method is: directly adding the code value sequence of the second code after the code value sequence of the first code. In addition, the code value sequence of the second code can be added before the code value sequence of the first code, or inserted into the code value sequence of the first code.

Based on the above, a unique SC code can be created by the combination of the first and second codes. The SC code can be used as an identification of authentication information.

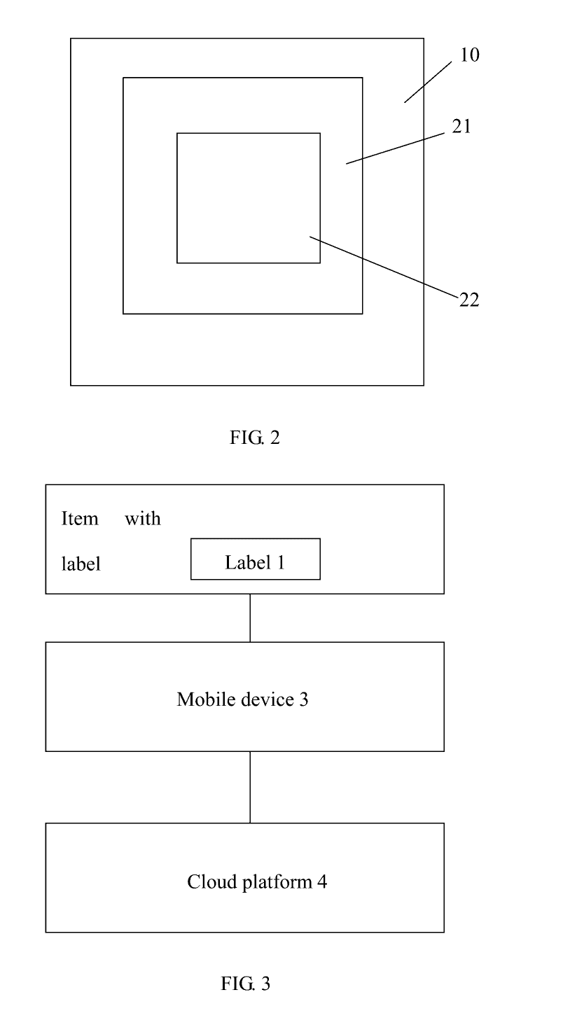

As shown in FIG. 2, a label 1 of an embodiment of the present application includes a label body 10. The label body 10 can be provided thereon with a first code 21 and a second code 22. The second code 22 can be superimposed on the first code 21. As mentioned before, the second code 22 is a combination of code elements of at least one color at at least one position in a region where the first code is located on the label body. As shown in FIG. 1, the code elements of the first code 21 and the code elements of the second code 22 occupy different physical locations on the same plane of projection. The code elements of the second code 22 can be embedded into a region not occupied by the code elements of the first code 21.

The label body 10 can be a single-layered structure. The first code 21 and the second 22 can be located on a single layer. In another embodiment, the label body 10 can be a multi-layered structure. The first code 21 and the second code 22 can be located on different layers of the label body 10. The label body 10 may be made of a film, a copper plate paper, or a card paper. A rear surface of the label body 10 may be coated with an adhesive layer for attachment to an item to be verified.

As shown in FIG. 3, the information authentication system of an embodiment of the present application includes a mobile device 3 and a cloud platform 4. The mobile device 3 can be used to collect the image formed by the combination of the first code and the second code on the label 1, and send the image to the cloud platform 4. The cloud platform 4 can be used to carry out authentication of the image, and send information that corresponds to the image to the mobile phone 3 after successful authentication. The mobile device 3 may, for example, include a camera-enabled notebook computer, smart phone, etc. The cloud platform 4 may include a server and a database. The server can be a massive cluster blade server. The database can be a local database of the server, or a remotely located cloud database, and connected through a network.

On the other hand, when authentication fails, i.e. when the cloud platform 4 compares the image with reference images in its database and finds out that no such image exists or the image is already invalid, then the cloud platform 4 can send a authentication failure prompting message to the mobile device 3.

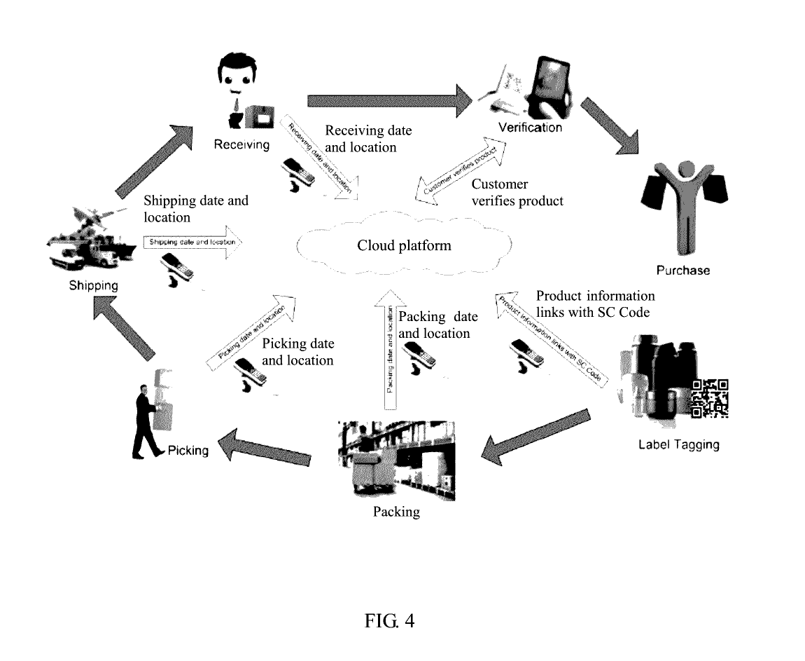

The information sent from the cloud platform 4 to the mobile device 3 may include tracking information on the item with the label 1. The information may include information on time and place of purchase, production, logistics, and sale, etc. Therefore, it can be used in areas such as loyalty reward programs, product tracking, anti-counterfeit, re-sale, etc. The mobile device 3 not only can identify authenticity, determine authenticity of items, confirm genuine product, it can also provide information on sale location, country of origin, production batches of raw material, date, and manufacturer for the entire process from purchasing to production, logistics and sales, to thereby thoroughly understand the product. As shown in FIG. 4, the entire process of the sale of the product can be fully tracked.

The information authentication method of an embodiment of the present application includes:
1) collecting the image on the label 1 adhered to the item by the mobile device 3, the image being formed by the combination of the first code 21 and the second code, wherein the second code is the combination of code elements of at least one color at at least one position in the region of the first code;
2) receiving the image collected from the mobile device 3 by the cloud platform 4, comparing the image with reference images in a cloud database, extracting a code value sequence that corresponds to the first code 21 and a code value sequence that corresponds to the second code 22, and combining the code value sequence that corresponds to the first code 21 with the code value sequence that corresponds to the second code 22 according to a predetermined combination method so as to obtain a code value sequence that corresponds to the image;
3) obtaining information that corresponds to the code value sequence that corresponds to the image by the cloud platform 4 according to a predetermined code value-information corresponding relationship, and transmitting the information that corresponds to the code value sequence to the mobile device 3.

The information authentication method of an embodiment of the present application, in practical application, includes the process of information encoding and decoding. The encoding process is usually based on the merchant. The cloud platforms can be a third-party authentication platform, or it can be, for example, an authentication website established by the merchant. For a third party authentication platform, for example, merchant can send product-related information to the cloud platform. The related information, as described earlier, can be information such as purchase, production, sales, dates, locations, etc. of the product. The information on the production and sale of the product can be updated by the merchant by sending the latest information to the cloud platform. Cloud platform saves the information in the database, and randomly allocates an information code directed to records of the information, i.e. the code value sequence that corresponds to the information, for example “iASFAidafal23XAdfaXAjkILKJ23”, which is then sent to the merchant. The merchant can divide the above sequence into a first part “iASFAidafal23X” and a second part “AdfaXAjkILKJ23” according to the predetermined combination method (reverse operation is the separation method). Then, the two separated parts of the sequence are encoded into corresponding QR code and CP code respectively. Finally, the corresponding QR codes and CP code are combined (e.g., superimposed together) to form a SC code. The SC code can be printed on a label, and the label can be attached to a product.

At the consumer's end, when a consumer purchases the product, the customer can use a mobile device to collect the SC code image on the label of the product, and upload the image to the cloud platform. The cloud platform will compare the image with reference images, and obtain the code value sequence that corresponds to the QR code and the code value sequence that corresponds to the of CP code of the SC code, and then combine them together according to the predetermined combination method. Then, information that corresponds to the combined code value sequence can be obtained and sent back to the customer to assist the consumer to complete the authentication.

The predetermined combination method can be assigned by the cloud platform. The merchant can also request update of the predetermined combination method. The predetermined combination method, for example, can be the one in the above example, i.e. adding the code value sequence that corresponds to the second code directly after the code value sequence that corresponds to the first code. The predetermined combination method can also be other preset combination method. Merchant can request update at any time, or periodically update the predetermined combination method or the code value-information correspondence relationship.

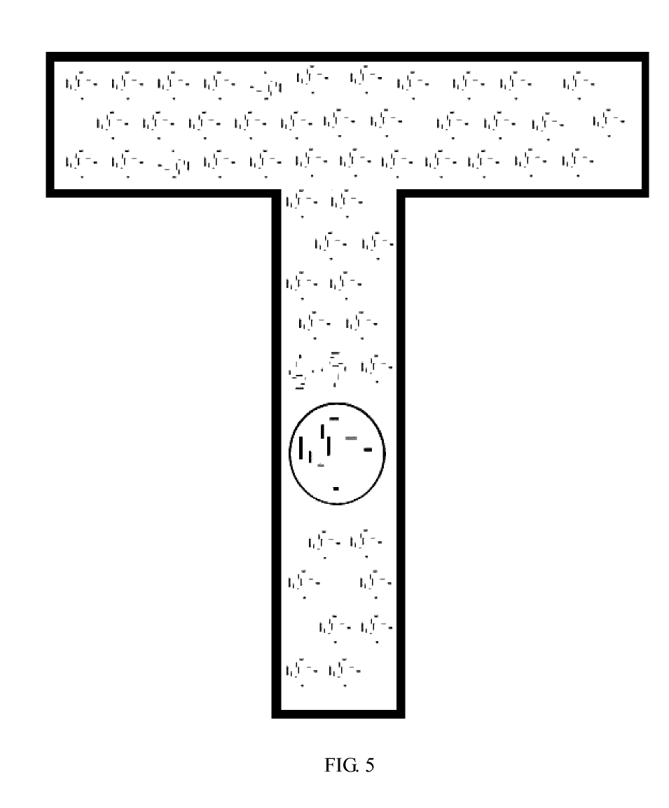

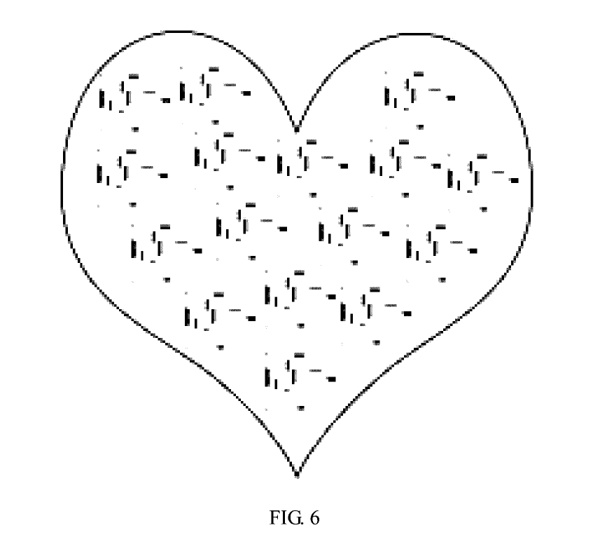

As shown in FIGS. 5 and 6, the code element region of a CP code can be applied to two-dimensional code of the QR code or other codes in any shape. The CP code itself can also be a set of CP codes in designated regions to form a specific shape and carry specific encoding information. The code element region of the CP code can be in various shapes, such as triangle, rectangle, circle, and square, etc. Similarly, the code element region of the CP code set can also be in various shapes. As shown in FIG. 5, it may include two code element region shapes of the CP code, namely a plurality of square CP codes in the periphery and a central circular CP code. The multiple CP codes form into a T-shape. As shown in FIG. 6, it merely includes a number of square CP codes, and the multiple CP codes form into a heart-shape. As mentioned earlier, encoded information can be implicitly shown by the color of every code element of the CP code and its position in the code element region. Also, it can be presented by the shape of the CP code and the shape of its combination. In FIG. 5, for example, a first coding can be formed by the color of every code element of the CP code and its position in the code element region. And then, for example, the square shape of the CP code can be encoded as number “1”. A new second coding can be formed after the number “1” is attached to the coding formed by the code element color and position. Furthermore, its position in the T-shaped code element combination is encoded as letter “A”. A third coding can be formed by adding the letter “A” to the second coding. Finally, the T-shaped CP code combination can be encoded as character “*”. A fourth coding can be formed by adding the character “*” to the third coding. It should be noted that, the above-mentioned coding method is only one example, and coding can be carried out by other methods. For example, the characters of the 2nd, 3rd and 4^{th} coding that are added to the 1^{st}, 2^{nd} and 3^{rd} coding can be added to the front, to the back, or to a specific location in the middle. The coding may not be carried out by addition. Different code mapping tables can be formed based on the shape of the CP code. For example, if it is square or rectangle, a row and column position mapping table can be used. If it is round, an angle regional mapping table can be used. That means different shapes of the CP code may correspond to different code mapping tables. Even though the color and position of its code elements are the same without consideration of the entire shape of the CP code, however since one of the shapes of the CP code is square and one is circle, different shapes of CP code have totally different coding sequence with different code position mapping tables. Similarly, information authentication of CP code and its combination can be carried out according to the above-mentioned information authentication method.

The label, information authentication system and method of the present application provide a combination of the first and second codes for information authentication. The second code is based on the color and position of the combined code elements, and authentication and information tracking of products are carried out by a cloud platform. The present application also provides a color positioning code or its combination for information authentication. Combination codes and color positioning codes of the system and method are not easy to duplicate. They have good anti-counterfeit effect, can carry a large amount of information, and can completely record all tracking information from production to sale of the product. Authentication is easy for customers. Only a camera-enabled mobile device is required for carrying out authentication. Hence, the entire system is low in cost. The system and method of the present application has full advantage in cost, information tracking and anti- counterfeit effect as compared to existing authentication methods such as authentication methods that require a NFC-enabled device, or invisible anti-counterfeit labels that require a special lens to observe, or labels that are visible only after scratching.

Specific embodiments have been described above with reference to the accompanying drawings. However, the present application is not limited to the above specific embodiments. The above specific embodiments are merely illustrative and should not be considered as limiting. It should be noted that, upon reading the above disclosure, a person skilled in the art can make various other changes or modifications without departing from the scope of the appended claims.

1. A label, comprising a label body, wherein the label body is provided thereon with a first code and a second code, the second code being superimposed on the first code, the second code is a combination of code elements of at least one color at at least one position in a region where the first code is located on the label body.

2. The label as claimed in claim 1, wherein the label body is a multilayered structure, the first code and the second code being located on different layers of the label body.

3. The label as claimed in claim 1, wherein the label body comprises a film, a copper plate paper, or a card paper.

4. The label as claimed in claim 1, wherein a rear surface of the label body is coated with an adhesive layer.

5. An information authentication system applying the label as claimed in claim 1, comprising a cloud platform for communicating with a mobile device; the cloud platform being configured to carry out authentication of an image formed by the combination of the first and second codes on the label collected and transmitted from the mobile device, and sending information that corresponds to the image to the mobile device after successful authentication.

6. The information authentication system as claimed in claim 5, further comprising an authentication failure prompting message to be transmitted from the cloud platform to the mobile device when authentication fails.

7. The information authentication system as claimed in claim 5, wherein the information comprises tracking information on an item on which the label is attached.

8. The information authentication system as claimed in claim 7, wherein the tracking information comprises information on time and place of purchase, production, logistics, and sale.

9. The information authentication system as claimed in claim 5, wherein the mobile device is a camera-enabled notebook computer or smart phone.

10. A method of authentication of information using the information authentication system as claimed in claim 5, comprising:
collecting the image on the label attached to the item by the mobile device, the image being formed by the combination of the first and second codes, wherein the second code is the combination of code elements of at least one color at at least one position in the region of the first code;
receiving the image collected from the mobile device by the cloud platform, comparing the image with reference images in a cloud database, extracting a code value sequence that corresponds to the first code and a code value sequence that corresponds to the second code, and combining the code value sequence that corresponds to the first code with the code value sequence that corresponds to the second code according to a predetermined combination method so as to obtain a code value sequence that corresponds to the image;
obtaining information that corresponds to the code value sequence that corresponds to the image by the cloud platform according to a predetermined code value-information corresponding relationship, and transmitting the information that corresponds to the code value sequence to the mobile device.

11. The information authentication method as claimed in claim 10, wherein the code value sequence is one or more combinations of numbers, letters and characters.

12. The information authentication method as claimed in claim 10, wherein the predetermined combination method comprises directly adding the code value sequence that corresponds to the second code after the code value sequence that corresponds to the first code.

13. The information authentication method as claimed in claim 10, further comprising: updating the predetermined combination method or the code value-information correspondence relationship periodically or in response to a command.

14. A label, comprising a label body, wherein the label body is provided thereon with a color position code, the color position code being a combination of code elements of at least one color at at least one position on the label body.

15. The label as claimed in claim 14, wherein the color position code has a code word region which is triangular, rectangular, circular, or square in shape.

16. The label as claimed in claim 14, wherein the label body is provided thereon with a code set formed by a plurality of the color position codes.

17. The label as claimed in claim 16, wherein the code word region of the code set is T-shaped or heart-shaped.

18. The label as claimed in claim 14, wherein the color position code of different shapes corresponds to different code mapping tables during coding.

19. An information authentication method based on the label as claimed in claim 14, wherein information authentication is carried out by an information authentication system, the information authentication system comprising: a cloud platform for communicating with a mobile device; the cloud platform being configured to carry out authentication of an image formed by the color position code on the label collected and transmitted from the mobile device, and sending information that corresponds to the image to the mobile device after successful authentication; the method comprising:
collecting the image on the label attached to an item by the mobile device, the image being an image of the color position code;
receiving the image collected from the mobile device by the cloud platform, comparing the image with reference images in a cloud database, obtaining a code value sequence that corresponds to the image utilizing a code mapping table according to shape of the color position code;
obtaining information that corresponds to the code value sequence that corresponds to the image by the cloud platform according to a predetermined code value-information corresponding relationship, and transmitting the information that corresponds to the code value sequence to the mobile device.

20. The information authentication method according to claim 19, further comprising: transmitting an authentication failure prompting message from the cloud platform to the mobile device when authentication fails; wherein the information comprises a tracking information on the item on which the label is attached, and the tracking information comprises information on time and place of purchase, production, logistics, and sale; and wherein the mobile device is a camera-enabled notebook computer or smart phone;
the code value sequence being one or more combinations of numbers, letters and characters; and further comprising updating a predetermined combination method or the code value-information corresponding relationship periodically or in response to a command.
